(19) United States
(12) Patent Application Publication
(10) Pub. No.: US 2025/0229676 A1
(43) Pub. Date: Jul. 17, 2025

(54) VEHICLE STRUCTURE

(71) Applicant: TOYOTA JIDOSHA KABUSHIKI KAISHA, Toyota-shi (JP)

(72) Inventor: Muneyuki IWATSUKI, Toyota-shi (JP)

(21) Appl. No.: 18/970,928

(22) Filed: Dec. 6, 2024

(30) Foreign Application Priority Data
Jan. 12, 2024 (JP) 2024-003429

(51) Int. Cl. B60N 2/07; B60N 3/04; B62D 21/03; B62D 25/02; B62D 25/20

(52) U.S. Cl. CPC B60N 2/0735; B60N 3/042; B62D 21/03; B62D 25/025; B62D 25/20

(57) ABSTRACT

A vehicle structure includes: a floor panel 24 that is disposed above a battery and that configures a floor surface of a vehicle cabin; a cross member 26 that is provided on the floor panel 24 and that extends in a vehicle width direction; a seat rail 22 that includes a lower rail 28, which is provided on the cross member 26, and an upper rail 30, which is supported so as to be slidable in a vehicle front-rear direction with respect to the lower rail 28, and that supports a vehicle seat; and an extension rail 30 that is disposed at a vehicle width direction outer side of the seat rail 22, and that extends further toward a vehicle front side than the seat rail 22, the lower rail 28 being engaged with the extension rail 30 so as to be moveable in the vehicle front-rear direction.

### CROSS-REFERENCE TO RELATED APPLICATION

This application is based on and claims priority under 35 USC 119 from Japanese Patent Application No. 2024-003429, filed on Jan. 12, 2024, the entire disclosure of which is incorporated by reference herein.

### BACKGROUND

### Technical Field

The present disclosure relates to a vehicle structure.

### Related Art

International Publication (WO) No. 2023/068307 discloses a structure in which a long slide rail is provided below a floor panel. Specifically, by including a first floor that supports the slide rail, and a second floor that is provided above the first floor, a structure in which the slide rail is embedded in the floor panel is realized, and the floor surface of the vehicle cabin is flattened. Further, the slide rail extends from a front end to a rear end of the vehicle cabin.

However, in a case of an electric vehicle in which a battery is installed below a floor panel, adopting a structure in which a slide rail is embedded reduces the space at the interior of the vehicle cabin, potentially impairing comfort.

### SUMMARY

An object of the present disclosure is to obtain a vehicle structure that is capable of increasing a sliding amount of a vehicle seat while ensuring comfort at an interior of a vehicle cabin.

A vehicle structure according to a first aspect includes: a floor panel that is disposed above a battery and that configures a floor surface of a vehicle cabin; a cross member that is provided on the floor panel and that extends in a vehicle width direction; a seat rail that includes a lower rail, which is provided on the cross member, and an upper rail, which is supported so as to be slidable in a vehicle front-rear direction with respect to the lower rail, and that supports a vehicle seat; and an extension rail that is disposed at a vehicle width direction outer side of the seat rail, and that extends further toward a vehicle front side than the seat rail, the lower rail being engaged with the extension rail so as to be moveable in the vehicle front-rear direction.

In the vehicle structure according to the first aspect, a floor panel is disposed above a battery, and a floor surface of a vehicle cabin is configured by the floor panel. Further, a cross member that extends in a vehicle width direction is provided on the floor panel. Furthermore, a seat rail that supports a vehicle seat is provided on the cross member, the seat rail including a lower rail and an upper rail that is supported so as to be slidable in a vehicle front-rear direction with respect to the lower rail. Therefore, sliding the upper rail with respect to the lower rail enables the vehicle seat to be moved toward the front and rear together with the upper rail.

Moreover, an extension rail, which extends further toward a vehicle front side than the seat rail, is disposed at a vehicle width direction outer side of the seat rail, and the lower rail is engaged with the extension rail so as to be moveable in the vehicle front-rear direction. This enables the entire seat rail to be moved toward the front and rear by moving the lower rail along the extension rail. Further, by providing the extension rail at a vehicle width direction outer side of the seat rail, the height of the seat rail does not need to be increased, thereby enabling the space at the interior of the vehicle cabin to be suppressed from becoming narrower.

A vehicle structure according to a second aspect is the vehicle structure according to the first aspect, wherein: a vehicle width direction end portion includes a rocker that extends in the vehicle front-rear direction; and the extension rail is fixed to the rocker.

In the vehicle structure according to the second aspect, the extension rail is fixed to the rocker, such that a load input from the vehicle seat can be transmitted to the rocker. Further, during a side-on collision of the vehicle, a collision load can be borne by the rocker and the extension rail.

A vehicle structure according to a third aspect is the vehicle structure according to the first aspect, wherein: the lower rail is fixed to the cross member via a lock mechanism; and a locked state by the lock mechanism is released in a case in which the vehicle seat is not in use.

In the vehicle structure according to the third aspect, the lower rail is fixed to the cross member via the lock mechanism, and a locked state by the lock mechanism is released in a case in which the vehicle seat is not in use. This enables the lower rail to be restrained from inadvertently moving while the locked state is maintained in a state in which the vehicle seat is in use.

A vehicle structure according to a fourth aspect is the vehicle structure according to the first aspect, wherein: the cross member and the extension rail are covered by a floor carpet.

In the vehicle structure according to the fourth aspect, the cross member and the extension rail are covered by a floor carpet, such that the designability of the interior of the vehicle cabin can be improved compared to a configuration in which the extension rail is exposed.

A vehicle structure according to a fifth aspect is the vehicle structure according to the first aspect, wherein: the seat rail and the extension rail are provided at a passenger seat side; and the extension rail extends below an instrument panel.

In the vehicle structure according to the fifth aspect, the extension rail extends below an instrument panel, such that the vehicle seat can be housed below the instrument panel when the vehicle seat at the passenger seat side is not in use.

As explained above, the vehicle structure according to the present disclosure enables the sliding amount of the vehicle seat to be increased while ensuring comfort at the interior of the vehicle cabin.

### BRIEF DESCRIPTION OF THE DRAWINGS

An exemplary embodiment of the present disclosure will be described in detail based on the following figures, wherein:

FIG. 1 is a side view illustrating a relevant portion of a vehicle cabin to which a vehicle structure according to an exemplary embodiment has been applied;

FIG. 2 is a side view illustrating a state in which a vehicle seat has been slid from the state in FIG. 1; and

FIG. 3 is an enlarged cross-section taken along line 3-3 in FIG. 1, illustrating an enlarged state.

### DETAILED DESCRIPTION

Explanation follows regarding a vehicle structure according to an exemplary embodiment, with reference to the drawings.

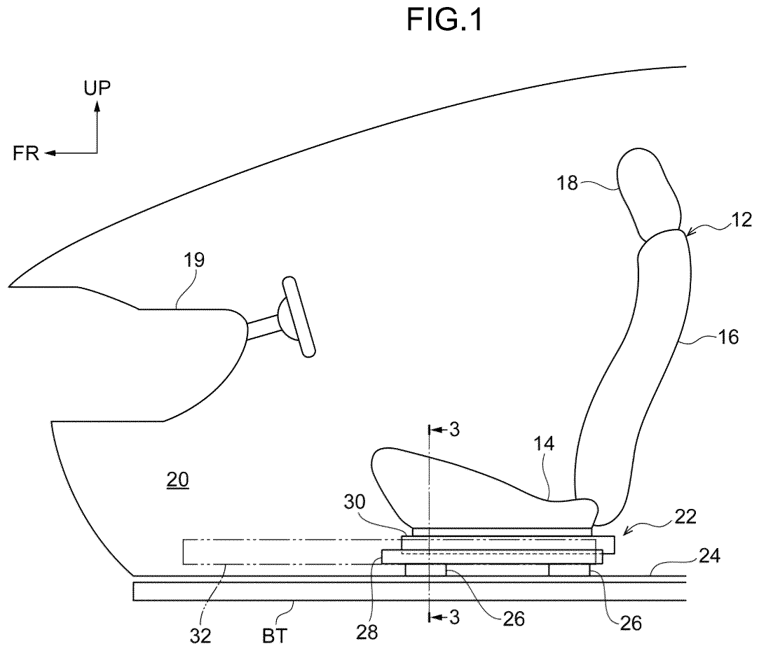

FIG. 1 is a side view illustrating a relevant portion of a vehicle cabin to which a vehicle structure according to an exemplary embodiment has been applied. It should be noted that in the drawings, the arrow FR, the arrow UP, and the arrow LH respectively indicate a vehicle frontward direction, a vehicle upper direction, and a vehicle leftward direction of a vehicle 10. Unless specifically stated otherwise, in the following explanation, reference to front and rear, up and down, and left and right directions refers to the front and rear in a vehicle front-rear direction, up and down in a vehicle up-down direction, and the left and right in a vehicle left-right direction (width direction), respectively.

As illustrated in FIG. 1, a vehicle seat 12 is provided at a front portion of a vehicle cabin to which the vehicle structure of the present exemplary embodiment has been applied. The vehicle seat 12 includes a seat cushion 14 that extends in the vehicle front-rear direction and the vehicle width direction and that is capable of supporting the buttocks and the thighs of an occupant.

A seatback 16 that is capable of supporting the back of an occupant is rotatably attached to the seat cushion 14 at a rear end portion of the seat cushion 14, and the seatback 16 extends in the vehicle up-down direction and the vehicle width direction. Further, a headrest 18 that is capable of supporting the head of an occupant is provided at an upper end portion of the seatback 16.

The vehicle seat 12 configured as described above is, for example, a seat at the passenger seat side, and a vehicle seat for a driver's seat, which is not illustrated in the drawings, is provided adjacent to the vehicle seat 12 in the vehicle width direction.

An instrument panel 19, serving as an interior material, is provided at a vehicle front side of the vehicle seat 12. Further, a space 20 is provided below the instrument panel 19. The space 20 is a space in which an occupant that is seated at the vehicle seat 12 at the passenger seat side puts his/her feet.

The vehicle seat 12 is provided above a floor panel 24 that configures a floor surface of the vehicle cabin, and a battery BT is provided below the floor panel 24. The battery BT stores electric power to be supplied to a motor, which is not illustrated in the drawings, and drives the motor to run the vehicle by supplying electric power to the motor from the battery BT. Namely, the vehicle of the present exemplary embodiment is an electric vehicle. It should be noted that an electric vehicle includes an electric vehicle (battery electric vehicle (BEV)), a hybrid vehicle (hybrid electric vehicle (HEV)), a plug-in hybrid vehicle (plug-in hybrid electric vehicle (PHEV)), a fuel cell vehicle (fuel cell electric vehicle (FCEV)), and the like.

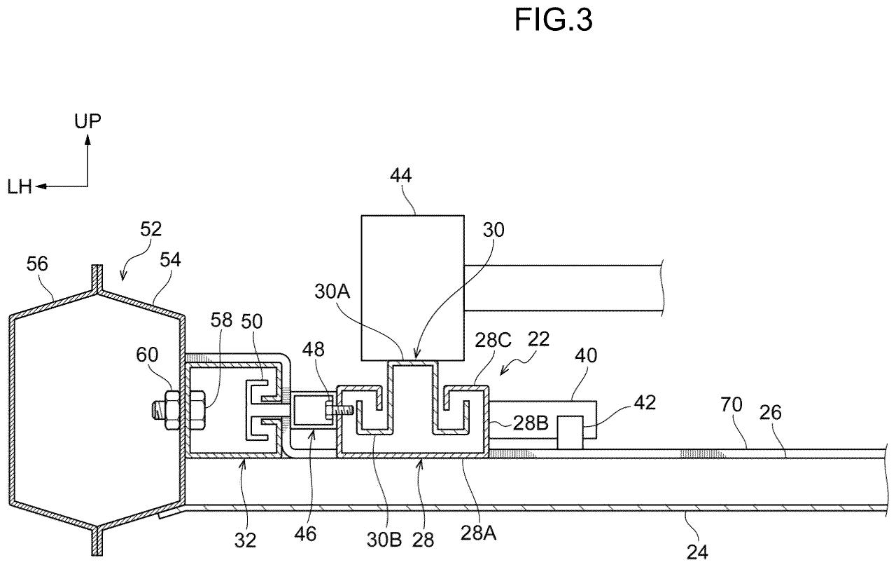

A cross member 26 is provided on the floor panel 24. The cross member 26 extends in the vehicle width direction, and connects frames of the vehicle to each other. Specifically, the cross member 26 couples a left and right pair of rockers 52, which extend in the vehicle front-rear direction, to each other in the vehicle width direction (see FIG. 3). It should be noted that in the present exemplary embodiment, two cross members 26 are provided with a spacing in the vehicle front-rear direction.

A seat rail 22 is provided on the cross members 26, and the vehicle seat 12 is attached to the cross members 26 via the seat rail 22. The seat rail 22 includes a lower rail 28 and an upper rail 30.

FIG. 3 is an enlarged cross-section taken along line 3-3 in FIG. 1, illustrating an enlarged state. As illustrated in FIG. 3, the lower rail 28 is disposed on the floor panel 24. Further, the lower rail 28 includes a bottom wall portion 28A that is in contact with the floor panel 24, side wall portions 28B that respectively extend upward from both vehicle width direction end portions of the bottom wall portion 28A, and upper wall portions 28C that extend toward a vehicle width direction inner side from respective upper end portions of the side wall portions 28B, and that are also bent toward a vehicle lower side.

The upper rail 30 is engaged with the lower rail 28. The upper rail 30 includes a rail main body portion 30A with a substantially U-shaped cross section as seen from the vehicle front-rear direction, and engagement portions 30B that each have a substantially L-shaped cross section that extends toward a vehicle width direction outer side from a lower end portion of the rail main body portion 30A and is bent further upward. A bearing, which is not illustrated in the drawings, is sandwiched between the lower rail 28 and the engagement portion 30B of the upper rail 30, and the upper rail 30 is supported so as to be capable of sliding in the vehicle front-rear direction with respect to the lower rail 28.

A seat frame 44 of the vehicle seat 12 is fixed to an upper surface of the rail main body portion 30A of the upper rail 30. Therefore, the upper rail 30 slides in the vehicle front-rear direction with respect to the lower rail 28, such that the vehicle seat 12 slides in the vehicle front-rear direction together with the upper rail 30.

A lock mechanism 40 is provided at the side wall portion 28B at a vehicle width direction outer side of the lower rail 28. The lock mechanism 40 includes a pawl portion, which is not illustrated in the drawings, that is capable of being anchored to a striker 42 that is installed upright on the floor panel 24, and the lower rail 28 is in a fixed state of being fixed to the cross member 26 due to the pawl portion of the lock mechanism 40 being anchored to the striker 42. Further, by actuating the lock mechanism 40 and releasing an anchored state between the pawl portion and the striker 42, the lower rail 28 is capable of moving with respect to the cross member 26.

It should be noted that in the present exemplary embodiment, as an example, a configuration is such that a locked state by the lock mechanism 40 is released when the vehicle seat 12 is not in use. For example, a controller, which is not illustrated in the drawings, such as an electronic control unit (ECU), may determine whether the vehicle seat 12 is in a use state or in a non-use state, and may release the locked state by the lock mechanism 40 in a case of determining that the vehicle seat 12 is in the non-use state.

The use state of the vehicle seat 12 can be determined using sensors such as a seating sensor, a buckle sensor, and a camera. For example, in a case in which it is detected that an occupant is seated at the vehicle seat 12 based on a signal from a seating sensor, the vehicle seat 12 is determined to be in the use state. Further, in a case in which it is detected that a seatbelt is mounted in a buckle of the passenger seat based on a signal from a buckle sensor, it may be determined that the vehicle seat 12 is in the use state. Further, in a case in which an occupant is seated at the vehicle seat 12 based on image data acquired from a camera that images an interior of the vehicle cabin, it may be determined that the vehicle seat 12 is in the use state.

An extension rail 32 is disposed at a vehicle width direction outer side of the seat rail 22. As illustrated in FIG. 1, the extension rail 32 extends further toward the vehicle front side than the seat rail 22, and a front end portion of the extension rail 32 is positioned in the space 20 below the instrument panel 19.

As illustrated in FIG. 3, the extension rail 32 has a substantially rectangular outer shape as seen from the vehicle front-rear direction. Further, a through hole is formed in a wall face of the extension rail 32 which faces the seat rail 22, and a support portion 50 of a coupling member 46 is inserted into the through hole.

The coupling member 46 is provided between the lower rail 28 and the extension rail 32, and the coupling member 46 and the lower rail 28 are fastened by a bolt 48. It should be noted that although not illustrated in the drawings, a nut that is screwed to the bolt 48 is provided at the interior of the lower rail 28.

The support portion 50 is provided at a vehicle width direction outer side face of the coupling member 46. The support portion 50 extends out toward the vehicle width direction outer side and is inserted into the interior of the extension rail 32, and a leading end of the support portion 50 is branched up and down and supported by the extension rail 32 via a bearing, which is not illustrated in the drawings. Therefore, the coupling member 46 is capable of sliding in the vehicle front-rear direction with respect to the extension rail 32.

A vehicle width direction outer side wall face of the extension rail 32 is fastened (fixed) to the rocker 52 by a bolt 58 and a nut 60.

The rocker 52 is a skeleton member with a closed cross-section extending in the vehicle front-rear direction, and includes a rocker inner panel 54 and a rocker outer panel 56. The rocker inner panel 54 is formed in a cross-section that is open at the vehicle width direction outer side in a substantially hat shape. The rocker outer panel 56 is formed in a cross-section that is open at the vehicle width direction inner side in a substantially hat shape, and is joined to the rocker inner panel 54.

It should be noted that a floor carpet 70 is provided on the floor panel 24, and the floor carpet 70 covers the cross member 26 and the extension rail 32.

As described above, the extension rail 32 is fixed to the rocker 52, and the coupling member 46 is capable of sliding in the vehicle front-rear direction with respect to the extension rail 32. Namely, the lower rail 28 is engaged with the extension rail 32 so as to be capable of moving in the vehicle front-rear direction. Therefore, in a state in which the locked state by the lock mechanism 40 is released, sliding the lower rail 28 in the vehicle front-rear direction with respect to the extension rail 32 enables the vehicle seat 12 to move together with the seat rail 22 in the vehicle front-rear direction.

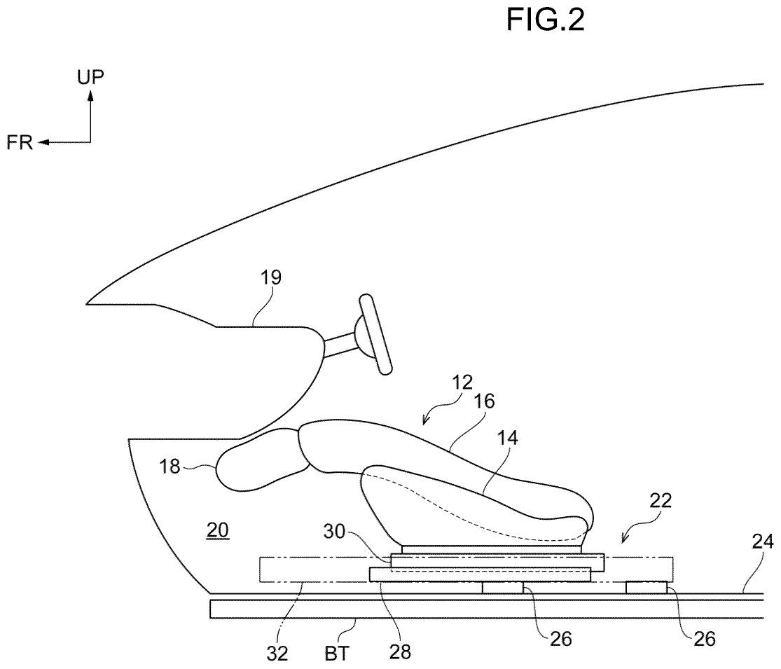

FIG. 2 is a side view illustrating a state in which the vehicle seat 12 has been slid toward the vehicle front side from the state in FIG. 1. As illustrated in FIG. 2, in the non-use state of the vehicle seat 12, by sliding the seat rail 22 toward the vehicle front side with respect to the extension rail 32 and folding the seatback 16, the vehicle seat 12 can be housed in the space 20 under the instrument panel 19.

### Operation

Next, explanation follows regarding operation of the vehicle structure according to the present exemplary embodiment.

In the vehicle structure according to the present exemplary embodiment, as illustrated in FIG. 1, the floor panel 24 is disposed above the battery BT, and the floor panel 24 configures a floor surface of the vehicle cabin. Further, the cross member 26 that extends in the vehicle width direction is provided on the floor panel 24. Furthermore, the seat rail 22 that supports the vehicle seat 12 is provided on the cross member 26, and the seat rail 22 includes the lower rail 28 and the upper rail 30 that is supported so as to be capable of sliding in the vehicle front-rear direction with respect to the lower rail 28. Therefore, sliding the upper rail 30 with respect to the lower rail 28 enables the vehicle seat 12 to be moved to ward the front and rear together with the upper rail 30.

As illustrated in FIG. 3, the extension rail 32 that extends further toward the vehicle front side than the seat rail 22 is disposed at the vehicle width direction outer side of the seat rail 22, and the lower rail 28 is engaged with the extension rail 32 so as to be capable of moving in the vehicle front-rear direction. Therefore, moving the lower rail 28 along the extension rail 32 enables the entire seat rail 22 to move toward the front and rear. Further, by providing the extension rail 32 at the vehicle width direction outer side of the seat rail 22, the height of the seat rail 22 does not need to be increased, thereby enabling the space at the interior of the vehicle cabin to be suppressed from becoming narrower.

In the present exemplary embodiment, the extension rail 32 is fixed to the rocker 52, such that a load input from the vehicle seat 12 can be transmitted to the rocker 52. Further, during a side-on collision of the vehicle, a collision load can be borne by the rocker 52 and the extension rail 32.

In the present exemplary embodiment, the lower rail 28 is fixed to the cross member 26 via the lock mechanism 40, and the locked state by the lock mechanism 40 is released when the vehicle seat 12 is not in use. This enables the lower rail 28 to be restrained from inadvertently moving while the locked state is maintained in a state in which the vehicle seat 12 is in use.

Further, in the present exemplary embodiment, the cross member 26 and the extension rail 32 are covered by the floor carpet 70, such that the designability of the interior of the vehicle cabin can be improved compared to a configuration in which the extension rail 32 is exposed.

Since the extension rail 32 extends below the instrument panel 19, the vehicle seat 12 can be housed below the instrument panel 19 when the vehicle seat 12 at the passenger seat side is not in use. In this manner, it is possible to increase the sliding amount of the vehicle seat 12 while ensuring comfort at the interior of the vehicle cabin.

Although explanation has been given regarding the vehicle structure according to the present exemplary embodiment, obviously various embodiments may be implemented within a range not departing from the gist of the present disclosure. For example, in the above-described exemplary embodiment, although the extension rail 32 is fixed to the rocker 52, the present disclosure is not limited thereto, and a configuration in which the extension rail 32 is separated from the rocker 52 may be employed. In such a case, fixing the extension rail 32 to the cross member 26 or the like enables a fixed state of the extension rail 32 to be satisfactorily maintained.

Further, in the above-described exemplary embodiment, although the lower rail 28 is fixed to the cross member 26 using the lock mechanism 40 and the striker 42, the present disclosure is not limited thereto. For example, a lock pin that is capable of moving in the up-down direction may be provided at the cross member 26, and the lower rail 28 may be locked by the lock pin passing through a lower wall portion of the lower rail 28 in a state in which the vehicle seat 12 is in use. In such a case, the fixed state between the lower rail 28 and the cross member 26 is released by lowering the lock pin in the non-use state of the vehicle seat 12.

In the above-described exemplary embodiment, although the lower rail 28 is capable of sliding with respect to the extension rail 32 by the coupling member 46 provided at the lower rail 28, the present disclosure is not limited thereto. For example, the shapes and structures of the coupling member 46 and the support portion 50 may be changed. Further, there is no particular limitation on the shape of the extension rail 32, and other shapes and structures may be employed as long as the lower rail 28 is capable of sliding with respect to the extension rail 32.

With regard to the above-described exemplary embodiment, the following additional notes are disclosed.

### Additional Note 1

A vehicle structure, including: a floor panel that is disposed above a battery and that configures a floor surface of a vehicle cabin; a cross member that is provided on the floor panel and that extends in a vehicle width direction; a seat rail that includes a lower rail, which is provided on the cross member, and an upper rail, which is supported so as to be slidable in a vehicle front-rear direction with respect to the lower rail, and that supports a vehicle seat; and an extension rail that is disposed at a vehicle width direction outer side of the seat rail, and that extends further toward a vehicle front side than the seat rail, the lower rail being engaged with the extension rail so as to be moveable in the vehicle front-rear direction.

### Additional Note 2

The vehicle structure according to Additional Note 1, wherein: a vehicle width direction end portion includes a rocker that extends in the vehicle front-rear direction; and the extension rail is fixed to the rocker.

### Additional Note 3

The vehicle structure according to Additional Note 1 or Additional Note 2, wherein: the lower rail is fixed to the cross member via a lock mechanism; and a locked state by the lock mechanism is released in a case in which the vehicle seat is not in use.

### Additional Note 4

The vehicle structure according to any one of Additional Note 1 to Additional Note 3, wherein: the cross member and the extension rail are covered by a floor carpet.

### Additional Note 5

The vehicle structure according to any one of Additional Note 1 to Additional Note 4, wherein: the seat rail and the extension rail are provided at a passenger seat side; and the extension rail extends below an instrument panel.

What is claimed is:

1. A vehicle structure, comprising:
a floor panel that is disposed above a battery and that configures a floor surface of a vehicle cabin;
a cross member that is provided on the floor panel and that extends in a vehicle width direction;
a seat rail that includes a lower rail, which is provided on the cross member, and an upper rail, which is supported so as to be slidable in a vehicle front-rear direction with respect to the lower rail, and that supports a vehicle seat; and
an extension rail that is disposed at a vehicle width direction outer side of the seat rail, and that extends further toward a vehicle front side than the seat rail, the lower rail being engaged with the extension rail so as to be moveable in the vehicle front-rear direction.

2. The vehicle structure according to claim 1, wherein:
a vehicle width direction end portion comprises a rocker that extends in the vehicle front-rear direction; and
the extension rail is fixed to the rocker.

3. The vehicle structure according to claim 1, wherein:
the lower rail is fixed to the cross member via a lock mechanism; and
a locked state by the lock mechanism is released in a case in which the vehicle seat is not in use.

4. The vehicle structure according to claim 1, wherein:
the cross member and the extension rail are covered by a floor carpet.

5. The vehicle structure according to claim 1, wherein:
the seat rail and the extension rail are provided at a passenger seat side; and
the extension rail extends below an instrument panel.
